(19) United States
(12) Patent Application Publication
(10) Pub. No.: US 2022/0185731 A1
(43) Pub. Date: Jun. 16, 2022

(54) CEMENT-BASED CALCINED BOARD-SHAPED CONSTRUCTION MATERIAL

(71) Applicant: SEKISUI HOUSE, LTD., Osaka-shi, Osaka (JP)

(72) Inventor: Masato FURUKAWA, Osaka-shi Osaka (JP)

(21) Appl. No.: 17/284,182

(22) PCT Filed: Jun. 23, 2020
(86) PCT No.: PCT/JP2020/024613

§ 371 Date: Apr. 9, 2021

(51) Int. Cl. C04B 20/10; C04B 14/22; C04B 14/04; C04B 14/42; C04B 41/50

(52) U.S. Cl. CPC C04B 20/1074; C04B 14/22; C04B 26/285; C04B 14/42; C04B 41/5024; C04B 14/041

(57) ABSTRACT

An object of the present invention is to obtain a cement-based calcined board-shaped construction material having improved impact resistance.

The cement-based calcined board-shaped construction material of the present invention is characterized by being produced by adding 0.5 to 5 wt % of a ceramic inorganic fiber and/or a mineral inorganic fiber to 100 wt % of a compound comprising 5 to 40 wt % of Portland cement, 5 to 30 wt % of a glass powder, and a remainder occupied by a refractory aggregate mainly composed of a silica-alumina refractory raw material, kneading the resulting material, then shaping the kneaded material into an elongated board shape by extrusion, and subsequently calcining the shaped material.

Also, it is the cement-based calcined board-shaped construction material which is produced by sticking a glass fiber sheet to the rear side of the cement-based calcined board-shaped construction material.

### TECHNICAL FIELD

The present invention relates to a cement-based calcined board-shaped construction material superior in weather resistance and durability.

### BACKGROUND ART

Board-shaped construction materials for use as interior/exterior materials of buildings, exteriors, tunnel interior materials, etc. are required to be superior in appearance, weather resistance, impact resistance, fire resistance, simplification of construction, etc.

The materials that constitute such board-shaped construction materials are cement-based boards or metal boards. However, cement-based boards are inferior in durability because they are commonly uncalcined. Metal boards are superior in impact resistance due to their flexibility, but they have a problem of oxidative deterioration. In addition, both cement-based boards and metal boards are colored on their surface by resin coating, so that they are poor in weather resistance.

Under such situations, the applicant of the present application previously proposed a cement-based calcined board-shaped construction material (see Patent Literature 1). This material is a calcined product and is superior in durability. The surface color thereof has a color tone of the material itself or is colored by glazing, so that it has no problem in weather resistance.

### CITATION LIST

### Patent Literature

Patent Literature 1: Japanese Patent Application Laid-Open No. 8-133825

### SUMMARY OF THE INVENTION

### Technical Problems

If the cement-based calcined board-shaped construction material is damaged by the impact of flying objects or the like, it will scatter or fall off, causing a serious accident. The above-described calcined board proposed by the present applicant is superior to calcined boards made of conventional materials in terms of impact resistance, but it is by no means satisfactory. An object of the present invention is to obtain a cement-based calcined board-shaped construction material having improved impact resistance.

### Solution To Problems

The cement-based calcined board-shaped construction material of the present invention is characterized by being produced by adding 0.5 to 5 wt % of a ceramic inorganic fiber and/or a mineral inorganic fiber to 100 wt % of a compound comprising 5 to 40 wt % of Portland cement, 5 to 30 wt % of a glass powder, and a remainder occupied by a refractory aggregate mainly composed of a silica-alumina refractory raw material, kneading the resulting material, then shaping the kneaded material into an elongated board shape by extrusion, and subsequently calcining the shaped material.

It is a known technique to add inorganic fibers in order to impart strength to an inorganic shaped article. The effect of imparting strength by the addition of the inorganic fibers, especially, improvement in impact resistance, which cement-based calcined board-shaped construction materials are required to have, has been made more remarkable by the present invention.

In the case of a calcined board-shaped construction material, it is conceivable that the inorganic fibers which have been added to the material are melted or some of them disappear when high temperature is applied during the calcination of the construction material, causing a shrinkage of volume, so that the tractional supporting force of construction material structure is not satisfactorily exhibited.

The calcined board-shaped construction material according to the present invention contains 5 to 30 wt % of a glass powder. The glass component softens or melts in a relatively low temperature range of around 1000° C. or lower, and forms a glass film around the fibers existing in the construction material structure. Then, this glass film acts to prevent the diffusion of the fiber component and to support the fusion of the fibers.

The calcined board-shaped construction material obtained by the present invention has significantly improved impact resistance, and it is presumed that the reason is due to the action of the glass powder.

For example, clay, silica stone, etc. chemically contain SiO2, which is the main component of glass. However, the effect of the present invention by the glass powder cannot be obtained probably because SiO2 is stabilized as a mineral composition combined with other components.

When a glass fiber sheet is stuck to the rear side of the calcined board-shaped construction material with a synthetic resin adhesive, the effect of imparting strength such as impact resistance is further improved.

When a glass fiber sheet is stuck to the rear side of a construction material, if the construction material is poor in heat insulation property and is exposed to high temperature, the adhesive with which the glass fiber sheet is stuck generates gas or catches fire. In addition, if the adhesive is deteriorated in its function due to high temperature, the effect of imparting strength by the glass fiber sheet is also impaired.

In the present invention, the addition of inorganic fibers, which are added during the production of a calcined board-shaped construction material serves to form fine vacant spaces in the structure of the calcined board-shapes construction material to improve the heat insulation property of the construction material itself. When, especially, a thermosetting phenol resin is used as the adhesive to stick the glass fiber sheet, gas is generated only in a small amount and superior heat resistance is produced, further improved heat resistance is produced due to combination with the heat insulation effect of the construction material body produced by the above-described addition of inorganic fibers.

### Advantageous Effects of Invention

As described above, the calcined board-shaped construction material produced by the method of the present invention is dramatically superior in dimension accuracy and impact resistance which large calcined board-shaped construction materials are required to have. In addition, when a glass fiber sheet is stuck to the rear side, the reinforcing effect by the glass fiber sheet is further improved by selectively using a thermosetting phenol resin for the sticking.

### BRIEF DESCRIPTION OF THE DRAWINGS

FIG. 1 schematically shows a cross section perpendicular to the longitudinal direction of the calcined board-shaped construction material of an embodiment.

### DESCRIPTION OF EMBODIMENTS

The Portland cement to be used for the production of the body of a calcined board-shaped construction material includes high-early strength cement, ultra high-early strength cement, normal cement, etc., and normal cement is preferred from the workability and the economical efficiency in the production of a board-shaped construction material depending on the curing speed.

If the proportion of the Portland cement accounting for in the composition of the main body of a calcined board-shaped construction material is less than 5 wt %, a great shrinkage appears during calcination, resulting in poor dimensional accuracy. If it exceeds 40 wt %, the strength is poor and there is a problem in durability.

Specific examples of the glass powder include borate glass, borosilicate glass, silicate glass, phosphate glass, and soda glass. The particle diameter thereof is preferably 0.5 mm or less in order to make the fusion with inorganic fibers remarkable. More preferably, it is 0.3 mm or less. A glass powder having any particle size can be obtained from commercially available products.

If the proportion of the glass powder is less than 5 wt %, the impact resistance of the present invention cannot be obtained, and if it exceeds 30 wt %, calcination will proceed excessively, resulting in poor impact resistance also in this case.

Specific examples of the silica-alumina refractory raw material include chamotte, pyrophyllite, brick scraps mainly made of these, and ceramic roof tile scraps. The proportion of the silica-alumina refractory raw material is preferably 30 to 90 wt % though it is automatically determined depending on increase and decrease of the glass powder and the Portland cement.

As the refractory aggregate, clay, silica stone, silica sand, feldspar, etc. may be used besides the silica-alumina refractory raw material as long as the effect of the present invention is not impaired.

The inorganic fiber is a ceramic fiber such as silica fiber, alumina fiber, alumina-silica fiber, and glass fiber, or a mineral fiber such as rockwool, asbestos, and sepiolite. If the proportion of the inorganic fiber is less than 0.5 wt % in an external content with respect to 100 wt % of the compound, the effect of the present invention cannot be obtained in impact resistance and heat resistance. If it exceeds 5 wt %, the hardness of the kneaded product increases during the kneading of the calcined board-shaped construction material compound, and the workability during shaping decreases.

In the production of calcined board-shaped construction materials, synthetic or natural binders such as CMC (carboxymethylcellulose), MC (methylcellulose), PVA (polyvinyl alcohol), dextrin, and starch are further added to the above compound and additives, followed by kneading. Then, extrusion, curing, and drying are performed as usual, and calcination in a roller hearth kiln or the like is performed.

In extrusion, it is preferable to form continuous hollow holes in the longitudinal direction of the calcined board-shaped construction material for the purposes of weight reduction and heat insulation of the calcined board-shaped construction material. The calcination temperature is preferably 1000 to 1200° C.

The calcined board-shaped construction material is commonly glazed for its aesthetic appearance, weather resistance, etc. Preferably, the calcined board-shaped construction material obtained in the present invention is also glazed. For glazing, a glaze is applied to the surface of the calcined board-shaped construction material by a spray method, a flow coater method, or the like on the construction material before calcination. The glaze is vitrified during the calcination of the construction material, so that the construction material is glazed.

When a glass fiber sheet is stuck to the rear side of a calcined board-shaped construction material, the glass fiber sheet is a glass non-woven fabric, a glass woven cloth, a glass cloth such as a glass braided cloth, or a glass roving.

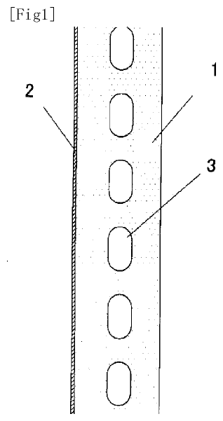

FIG. 1 schematically shows a cross section perpendicular to the longitudinal direction of the calcined board-shaped construction material according to the present invention. In the drawing, a glass fiber sheet (2) is stuck to the calcined board-shaped construction material (1) on the rear side thereof with an adhesive. The calcined board-shaped construction material (1) is provided with continuous hollow holes (3) in the longitudinal direction.

The adhesive to be used for sticking the glass fiber sheet is preferably a thermosetting phenol resin, which generates little curing shrinkage and is superior in heat resistance.

When, for example, a polyester resin or an epoxy resin is used as the adhesive, a large shrinkage is generated during adhesive curing, so that the calcined board-shaped construction material has a reduced dimensional accuracy due to its warpage. Such adhesives as ABS resin, silicone resin, and urethane resin exhibit relatively small shrinkage during adhesion, but because of their high elasticity (elongation), they cannot impart strength due to rigidity to the substrate side, and they cannot sufficiently improve the safety of products although they can prevent scattering and falling off when receiving an impact.

Moreover, unlike thermosetting phenol resins, this type of resin is unsuitable in terms of fire resistance because it generates gas when heated and may cause a secondary disaster in the event of a fire.

As a method of sticking the glass fiber sheet, a hand lay-up method is preferred for cloth and mat, and a spray-up method is preferred for roving. For drying after sticking, the adhesive is thermoset by passing it through a drying oven using an infrared ray, a hot air generator or the like as a heat source for a required time.

Preferably, the amount of the adhesive applied is 200 to 650 g/m2 when the construction material is certified as a semi-incombustible material and is 200 to 450 g/m2 when being certified as a non-combustible material.

### EXAMPLES

Examples and comparative examples of the present invention will be described below. Table 1 shows the compositions of the calcined board-shaped construction materials in the respective examples and the test results thereof. In each example, 2 wt % of MC (in an external content with respect to 100 wt % of the refractory aggregate) as a binder and 15 wt % of water (in an external content with respect to the entire compound containing the binder) were added to the compound shown in that table, kneaded with a kneader-ruder, and then shaped into an elongated hollow board having a length of 2000 mm, a width of 300 mm, and a thickness of 20 mm using a de-airing extrusion machine.

Subsequently, the product was cured, then heated and dried at 120° C. for 12 hours, and then rapidly calcined at 1100° C. for 3 hours with a roller hearth kiln. The test methods are as follows.

Flexural strength was measured in accordance with JIS A 1408 “Test method of bending for building boards”.

Impact resistance was measured in accordance with JIS-A1421 “Test method of impact for building boards”.

As to the dimensional accuracy, a calcination shrinkage rate was measured.

TABLE 1

| | | Example | | | | | | Comparative Example | | | |
|---|---|---|---|---|---|---|---|---|---|---|---|
| | | 1 | 2 | 3 | 4 | 5 | 6 | 1 | 2 | 3 | 4 |
| Composition | Normal Portland cement | 30 | 20 | 30 | 30 | 30 | 30 | 30 | 30 | 30 | 50 |
| w % | Silicate glass powder 0.15 mm or less | 5 | 10 | 20 | 30 | 30 | 30 | | 40 | | 10 |
| | Refractory clay | | | | | | | | | 20 | |
| | Chamotte 0.5 mm or less | 25 | 40 | 20 | 20 | 20 | 20 | 40 | 10 | 20 | 20 |
| | Pyrophyllite 0.5 mm or less | 40 | 30 | 30 | 20 | 20 | 20 | 30 | 20 | 30 | 20 |
| | Ceramic fiber (glass fiber) | (1) | (3) | (4) | (2) | | | (3) | (3) | (3) | (3) |
| | Mineral fiber (rockwool) | | | | | (2) | (3) | | | | |
| Test | Flexural strength (kg f/cm²) | 130 | 140 | 170 | 140 | 145 | 165 | 50 | 170 | 100 | 70 |
| | Impact resistance (kg · cm) | 25 | 30 | 40 | 25 | 30 | 30 | 10 | 10 | 5 | 10 |
| | Calcination shrinkage rate (%) | 0.1 | 0.2 | 0.3 | 0.2 | 0.2 | 0.3 | 0.1 | 2.5 | 1.0 | 0.1 |

In the composition, the numbers in the parenthesis are in wt % in external content.

As shown by the test results in the table, the board-shaped construction materials obtained in the examples of the present invention were superior in both flexural strength and impact resistance.

On the other hand, Comparative Example 1, in which no glass powder was added, was inferior in flexural strength and impact resistance. Comparative Example 2, in which a glass powder was added but the addition amount exceeded the range of the present invention, was inferior in dimensional accuracy and impact resistance. Comparative Example 3, in which clay was added instead of a glass powder, was inferior especially in impact resistance. Further, Comparative Example 4, in which the proportion of Portland cement was large, was inferior in flexural strength and impact resistance.

In the examples, glass fiber and rock wool were used as the inorganic fibers to be added to the calcined board-shaped construction materials, but the same effect was obtained even by using other inorganic fibers.

Table 2 shows the test in the case where a glass fiber sheet was stuck to the rear side. A 1-mm thick glass fiber sheet made of a glass fiber non-woven fabric was adhered to the rear side of the calcined board-shaped construction material obtained in Example 2 shown in Table 1, by a hand lay-up method, and then heat curing treatment was carried out at 100° C. for 1 hour.

In Test Example 1, a glass fiber sheet was stuck using a thermosetting phenol resin as an adhesive. On the other hand, in Test Example 2, a glass fiber sheet was stuck using a polyester resin as an adhesive. In Test Example 3, a glass fiber sheet was stuck using a silicone resin as an adhesive.

Flexural strength and impact resistance were examined under the same conditions as the test methods described in the foregoing example.

Warpage was measured with a warpage measuring device.

Non-combustibility tests were carried out in accordance with the test method specified in Notification No. 1828 of the Ministry of Construction.

o . . . pass, × . . . fail

TABLE 2

| | | Test Example | | |
|---|---|---|---|---|
| | | 1 | 2 | 3 |
| Adhesive | Phenol resin | ∘ | | |
| | Silicone resin | | ∘ | |
| | Polyester resin | | | ∘ |
| Test | Flexural strength(kg f/cm²) | 250 | 200 | 150 |
| | Impact resistance(kg · cm) | 100 | 90 | 35 |
| | Warpage(mm) | 1 | 5 | 0.5 |
| | Non-combustibility test (evaluation) | ∘ | x | x |

In Test Example 1, the calcined board-shaped construction material exhibited further improvement in flexural strength and impact strength as a result of sticking a glass fiber sheet, and it exhibited only a small warpage. In the evaluation test regarding non-combustibility, the color of the glass fiber sheet changed only slightly, and no smoking, ignition, or peeling was observed.

On the other hand, in Test Example 2, the calcined board-shaped construction material exhibited a large warpage with shrinkage due to the curing of the adhesive, so that the dimensional accuracy was impaired. In addition, in the evaluation test related to non-combustibility, ignition and smoking were observed in the adhesive, and the glass fiber sheet was peeled off.

In Test Example 3 using a silicone resin as an adhesive, the impact resistance was insufficient and falling off did not occur in the impact resistance test, but no significant effect was obtained on impact resistance and cracks were generated on the surface. In the evaluation test related to non-combustibility, heat was significantly generated, and smoking and peeling of the glass fiber sheet were observed.

### REFERENCE SIGNS LIST

1 Calcined board-shaped construction material
2 Glass fiber sheet
3 Continuous hollow hole

1. A cement-based calcined board-shaped construction material produced by adding 0.5 to 5 wt % of a ceramic inorganic fiber and/or a mineral inorganic fiber to 100 wt % of a compound comprising 5 to 40 wt % of Portland cement, 5 to 30 wt % of a glass powder, and a remainder occupied by a refractory aggregate mainly composed of a silica-alumina refractory raw material, kneading the resulting material, then shaping the kneaded material into an elongated board shape by extrusion, and subsequently calcining the shaped material.

2. The cement-based calcined board-shaped construction material according to claim 1, wherein the particle diameter of the glass powder is 0.5 mm or less.

3. The cement-based calcined board-shaped construction material according to claim 2, wherein the calcination temperature is 1000 to 1200° C.

4. A cement-based calcined board-shaped construction material produced by sticking a glass fiber sheet to the rear side of the cement-based calcined board-shaped construction material according to claim 3 with a thermosetting phenol resin.
